(19) United States
(12) Patent Application Publication
(10) Pub. No.: US 2016/0125488 A1
(43) Pub. Date: May 5, 2016

(54) METHODS AND SYSTEMS TO ALLOCATE PHYSICAL NETWORK COST TO TENANTS OF A DATA CENTER

(71) Applicant: VMWARE, INC., Palo Alto, CA (US)

(72) Inventors: MRITYUNJOY SAHA, Bangalore (IN); KUMAR GAURAV, Bangalore (IN)

(21) Appl. No.: 14/600,041

(22) Filed: Jan. 20, 2015

(30) Foreign Application Priority Data
Nov. 4, 2014 (IN) 5525/CHE/2014

(51) Int. Cl. G06Q 30/04; H04L 12/911; G06F 9/455

(52) U.S. Cl. CPC G06Q 30/04; G06F 9/45533; H04L 47/822; G06F 2009/45595; G06F 2009/4557

(57) ABSTRACT

Systems and methods of allocating network cost of a physical data center to data center tenants are disclosed. In one aspect, the systems and methods compute a total cost of the physical data center devices and networks and other operational expenditures over a period of time. The systems and methods compute local network and Internet utilization for each VM over the full period. Network utilization is computed for each VM as a fraction of the total cost. The cost allocated to each tenant is computed as a sum of the total cost of all VMs used by the tenant.

### RELATED APPLICATIONS

Benefit is claimed under 35 U.S.C. 119(a)-(d) to Foreign application Serial No. 5525/CHE/2014 filed in India entitled “METHODS AND SYSTEMS TO ALLOCATE PHYSICAL NETWORK COST TO TENANTS OF A DATA CENTER”, filed on Nov. 4, 2014, by VMware, Inc., which is herein incorporated in its entirety by reference for all purposes.

### TECHNICAL FIELD

The present disclosure is directed to cost allocation, and, in particular, to computational systems and methods of determining physical network cost in a software defined data center and allocating the cost to consumers.

### BACKGROUND

In recent years, individuals and organizations have shifted much of their computing needs from localized computer systems to cloud computing service providers. Cloud computing service providers allow individuals and organizations called “tenants” to run their applications and purchase other computing services over a network, such as the Internet, in much the same way utility customers purchase a service from a public utility. Cloud computing service providers manage and maintain cloud computing facilities composed of servers, switches, routers, and mass data-storage devices interconnected by local-area networks, wide-area networks, wireless communications, and the Internet that may be distributed geographically or consolidated into data centers. Virtual machines (“VMs”) have become an integral part of executing a tenants applications. Because VMs are not bound physical devices, VMs can be moved to different physical servers of a cloud computing facility without affecting a user's experience in order to more efficiently use the cloud computing facility's computational resources. A cloud computing service provider typically provides each tenant one or more virtual data centers (“VDCs”) composed of the tenant's VMs. A VDC recreates the architecture and functionality of a physical data center for running a tenant's VMs. However, allocating total costs of using physical resources of a data center to run each tenant's VMs is often complicated by a wide variety of a data center devices and by changes in the type and quantity of data center devices over time.

### SUMMARY

This disclosure presents computational systems and methods of allocating network cost of a physical data center to tenants based on each tenant's usage of physical networks of the data center. In one aspect, the systems and methods compute a total cost of the physical data center devices and networks and other operational expenditures over a period of time. The systems and methods compute local network and Internet utilization for each VM over the full period. Network utilization is computed for each VM as a fraction of the total cost. The cost allocated to each tenant is computed as a sum of the total cost of all VMs used by the tenant. In another aspect, methods and systems may also be used to allocate network cost of a physical data center based on each tenant's use of servers.

### DESCRIPTION OF THE DRAWINGS

FIG. 1 shows a general architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine and virtual-machine execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows five example virtual-machine execution environments above a virtual-interface plane of a physical data center.

FIG. 12 shows an example table of device information for a device connected to a network of a physical data center.

FIG. 13 shows a flow diagram of computing an amortized cost of listed devices.

FIG. 14 shows an example table of discovered devices and corresponding amortized costs of each device.

FIG. 15 shows an example table of operational expenditures.

FIG. 16 shows a control-flow diagram of allocating network cost of a physical data center for a period of time.

FIG. 17 shows a control-flow diagram of the routine “compute capital expenditure” called in the control-flow diagram of FIG. 16.

FIG. 18 shows a control-flow diagram of the routine “compute operational expenditure” called in the control-flow diagram of FIG. 16.

FIG. 19 shows a control-flow diagram of the routine “compute LAN bandwidth utilization” called in the control-flow diagram of FIG. 16.

FIG. 20 shows a control-flow diagram of the routine “compute effective network cost” called in the control-flow diagram of FIG. 16.

### DETAILED DESCRIPTION

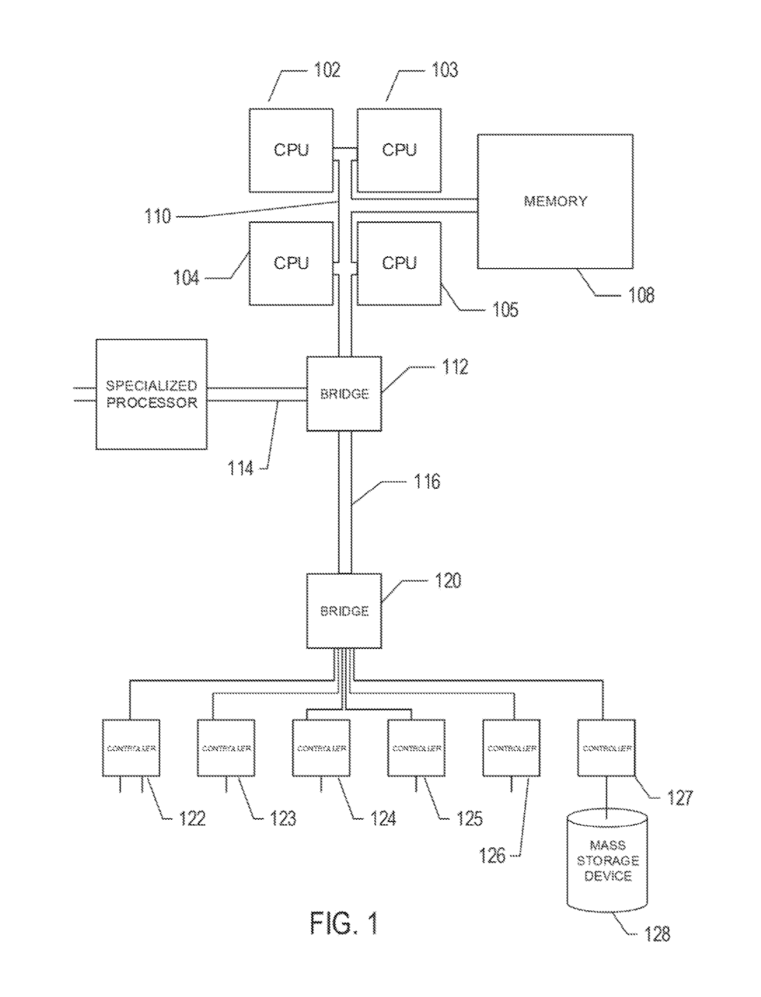

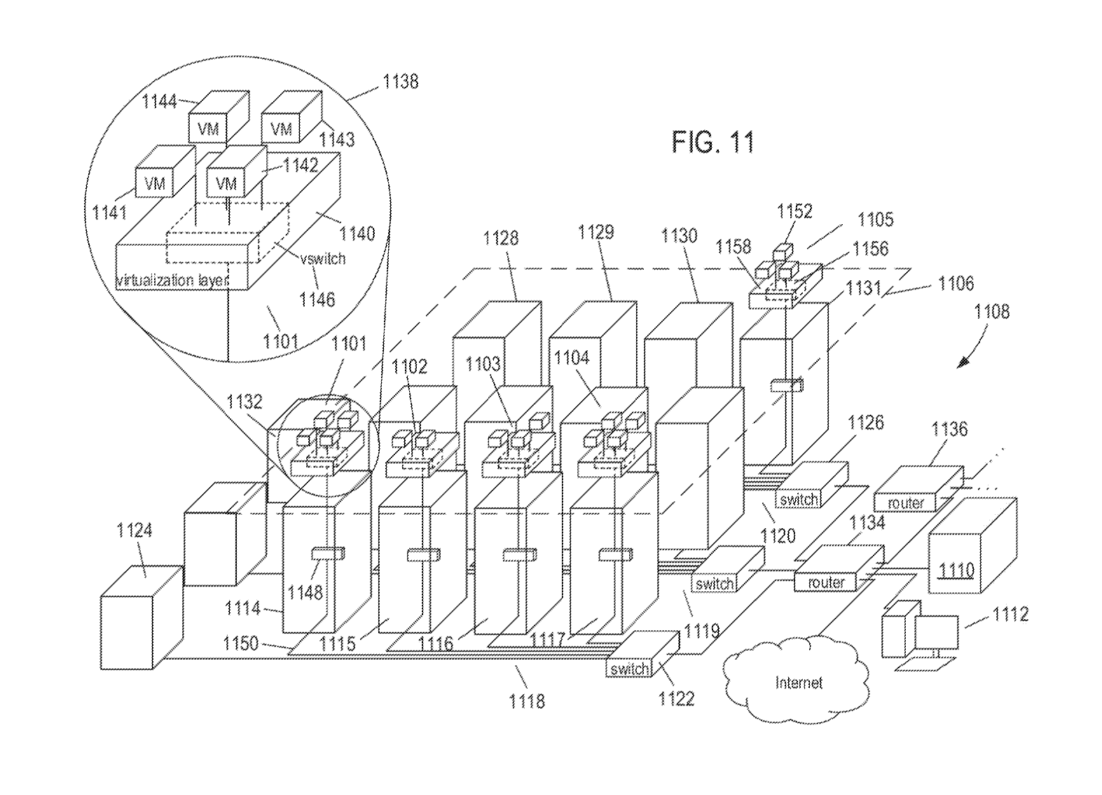

In a first subsection a detailed description of computer hardware, complex computational systems, and virtualization is provided with reference to FIGS. 1-10. In a second subsection, implementations of currently disclosed methods and systems that allocate network cost of a physical data center to tenants are discussed with reference to FIGS. 11-20.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

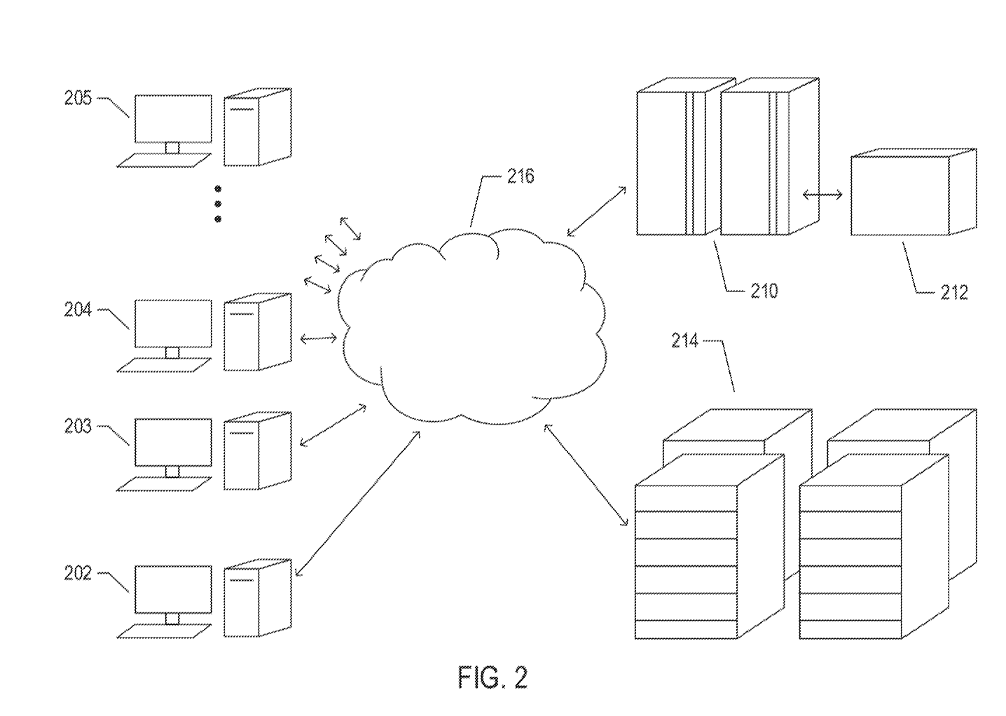

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

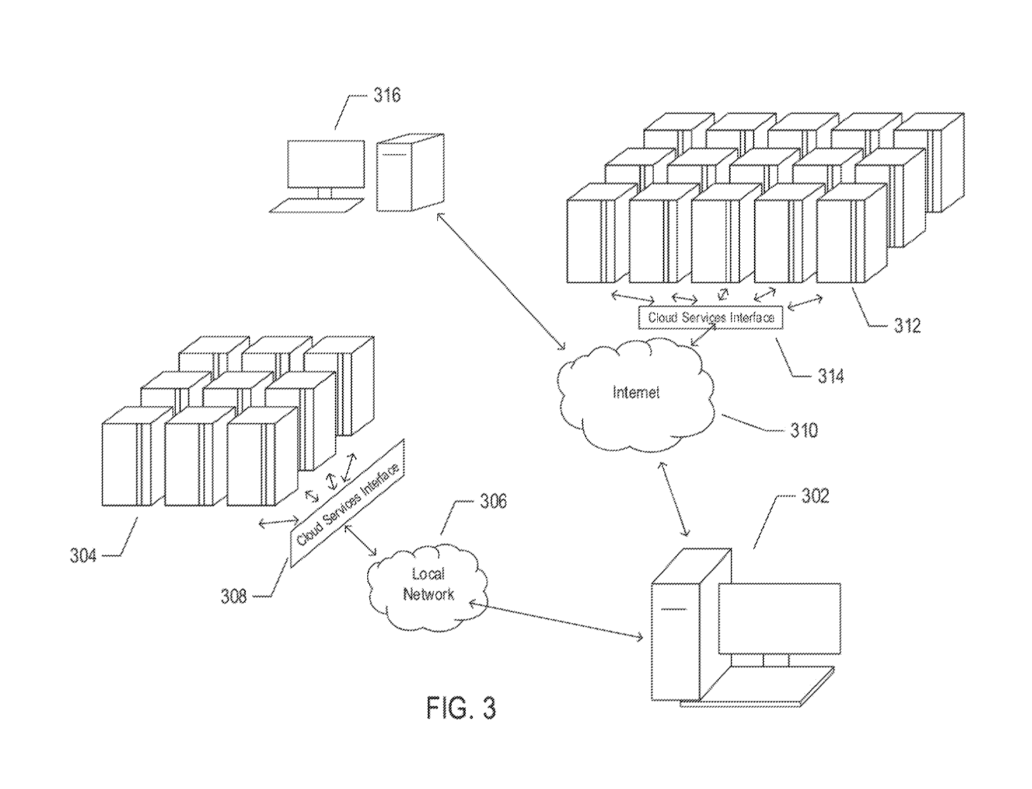

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

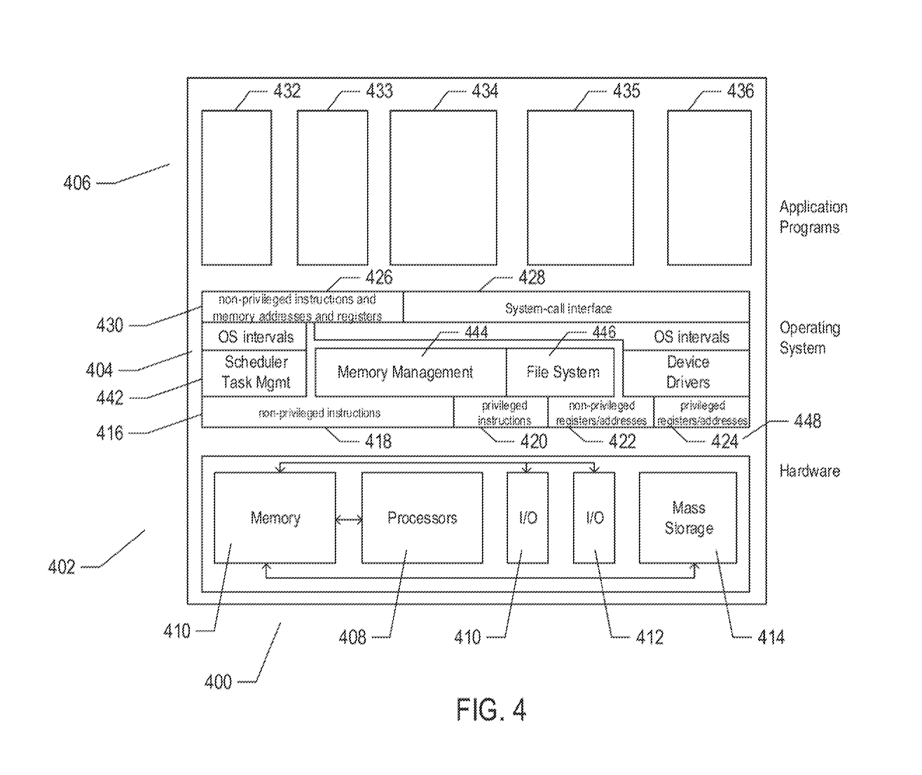

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

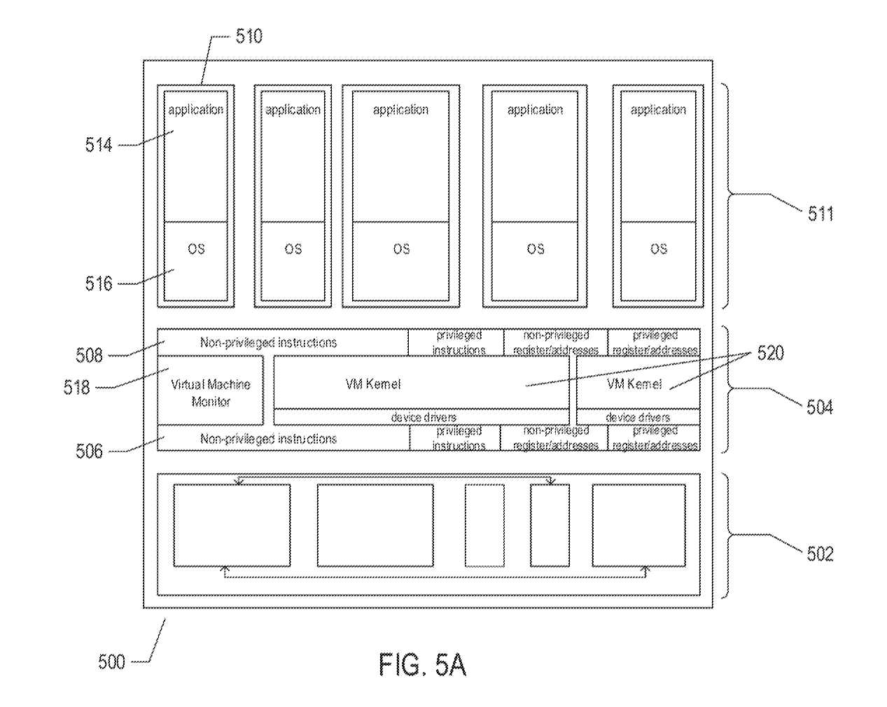

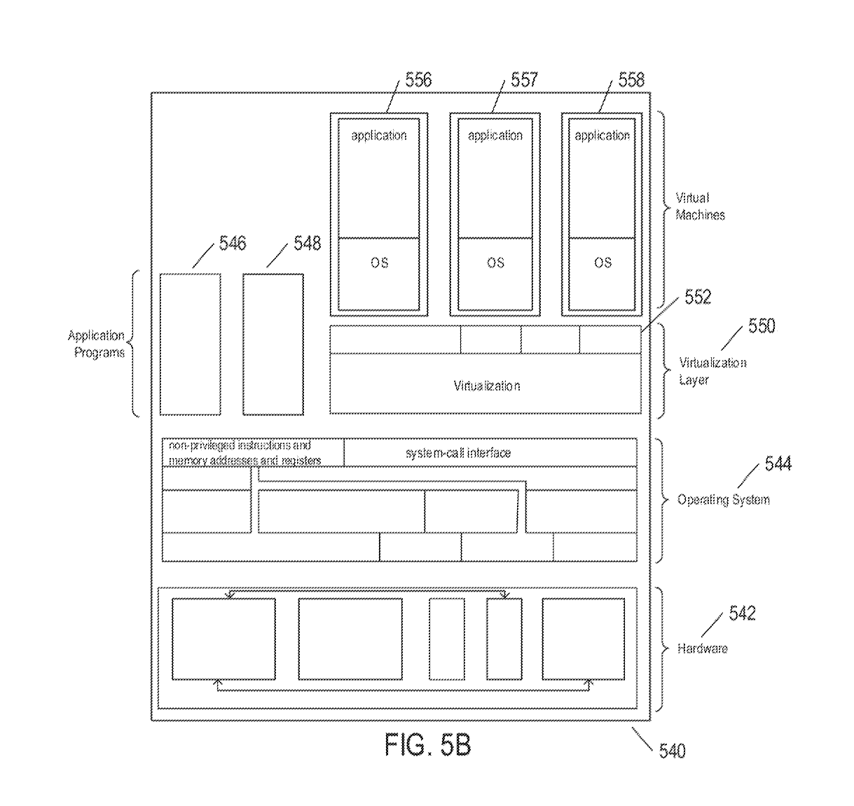

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in Figure SA features a virtualization layer 504 that interfaces through a virtualization-layer/hardware-layer interface 506, equivalent to interface 416 in FIG. 4, to the hardware. The virtualization layer 504 provides a hardware-like interface 508 to a number of VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization-layer interface 508 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization-layer interface 508 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization-layer interface 508, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In Figure SB, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

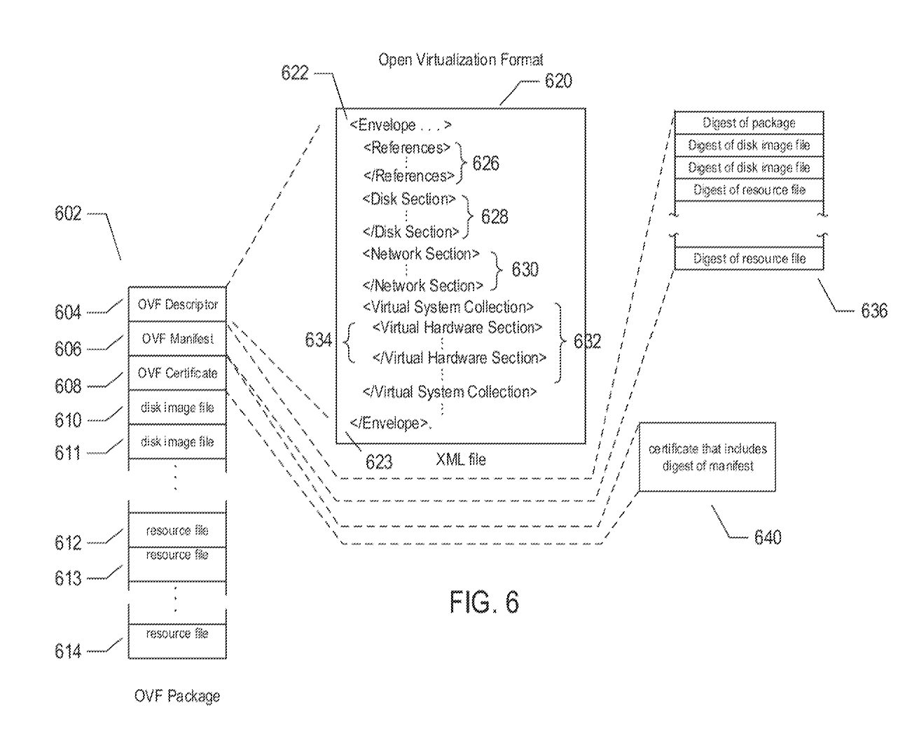

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or entirely eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

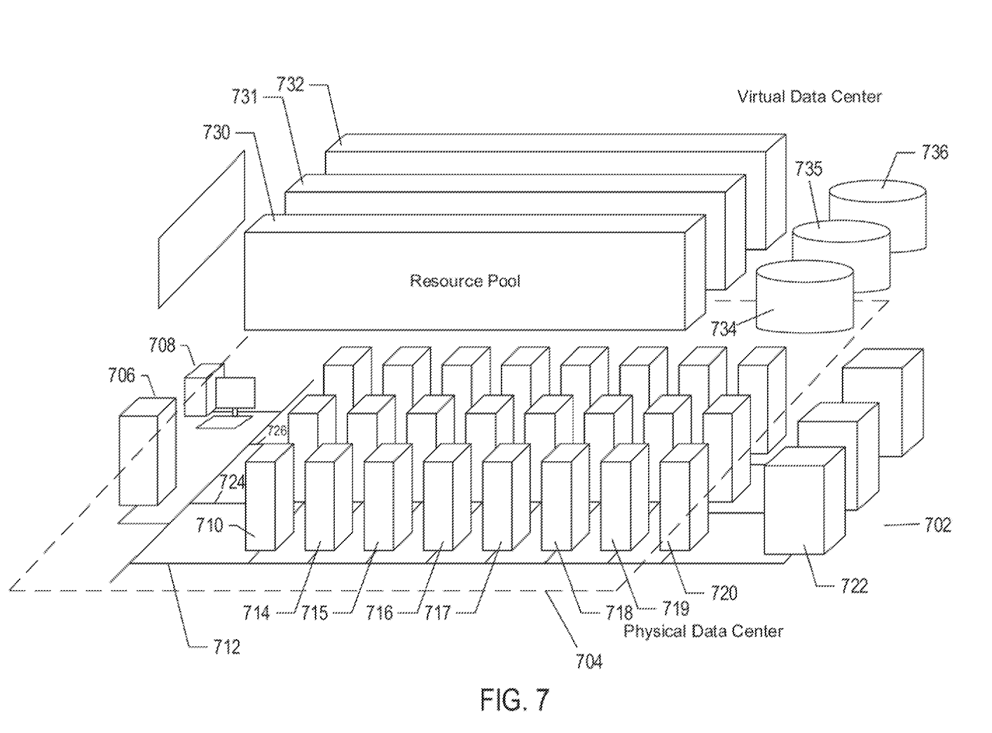

FIG. 7 shows virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of physical servers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server 706 includes functionality to migrate running VMs from one physical server to another in order to optimally or near optimally manage device allocation, provide fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual physical servers and migrating VMs among physical servers to achieve load balancing, fault tolerance, and high availability.

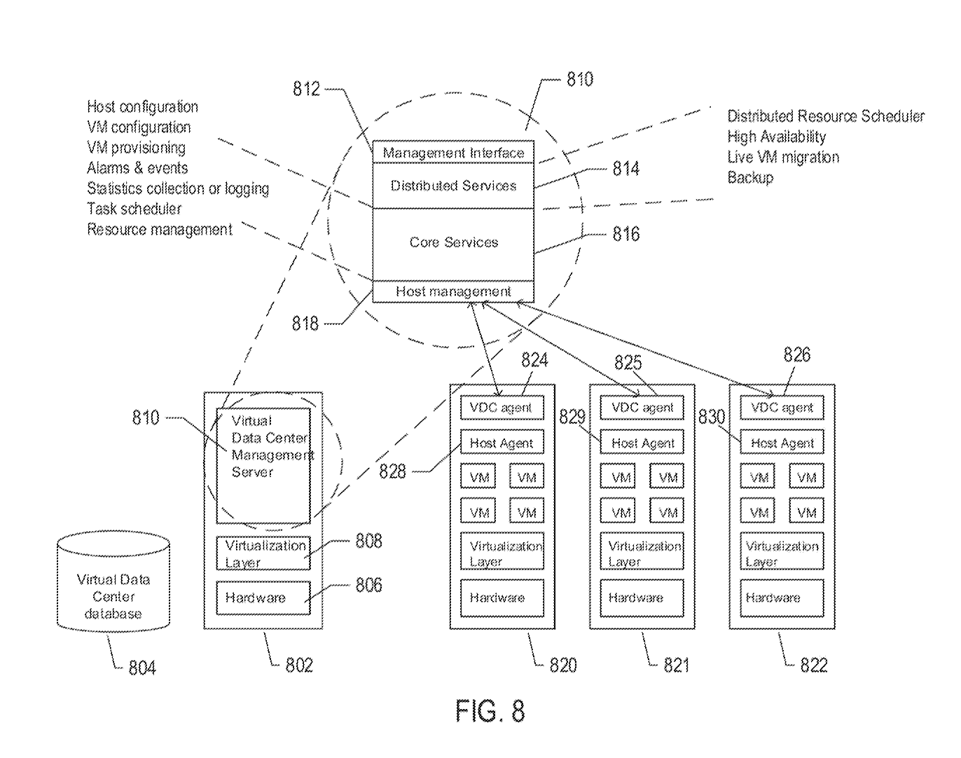

FIG. 8 shows virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server VM 810 above the virtualization layer. Although shown as a single server in FIG. 8, the virtual-data-center management server (“VDC management server”) may include two or more physical server computers that support multiple VDC-management-server virtual appliances. The VM 810 includes a management-interface component 812, distributed services 814, core services 816, and a host-management interface 818. The management interface 818 is accessed from any of various computers, such as the PC 708 shown in FIG. 7. The management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the physical servers of the physical data center that is abstracted to a virtual data center by the VDC management server.

The distributed services 814 include a distributed-device scheduler that assigns VMs to execute within particular physical servers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server, and restarts the VM on the different physical server from a virtual-machine state recorded when execution of the VM was halted. The distributed services 814 also include a distributed backup service that provides centralized virtual-machine backup and restore.

The core services 816 provided by the VDC management server 810 include host configuration, virtual-machine configuration, virtual-machine provisioning, generation of virtual-data-center alarms and events, ongoing event logging and statistics collection, a task scheduler, and a device-management module. Each physical server 820-822 also includes a host-agent VM 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce device allocations made by the VDC management server 810, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

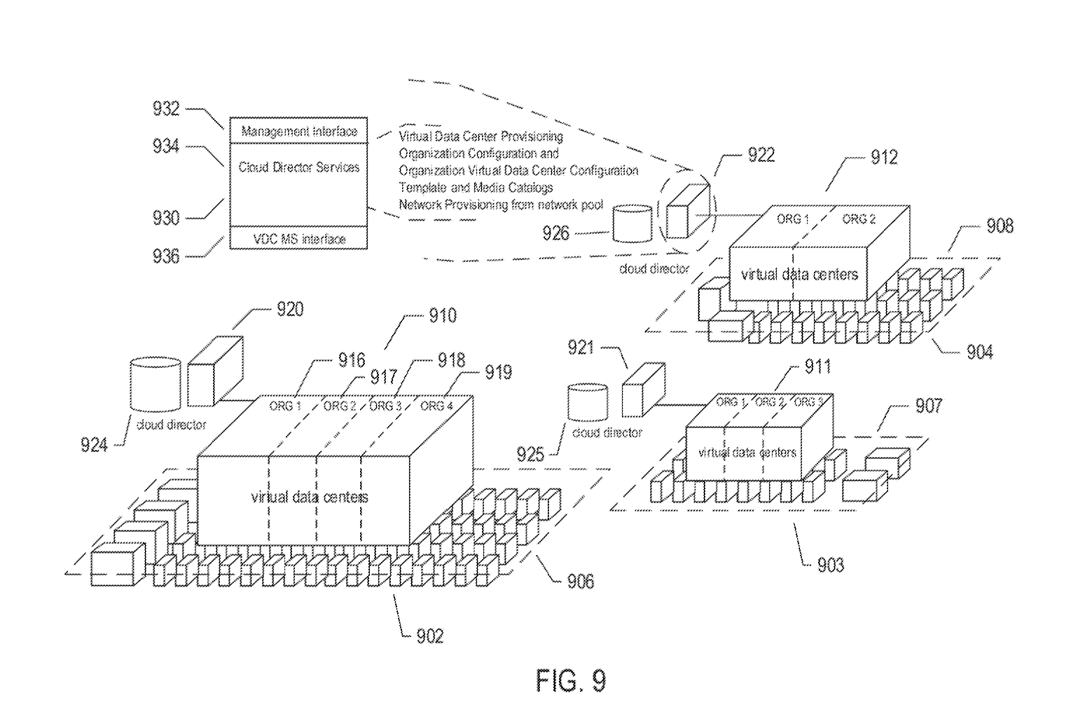

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

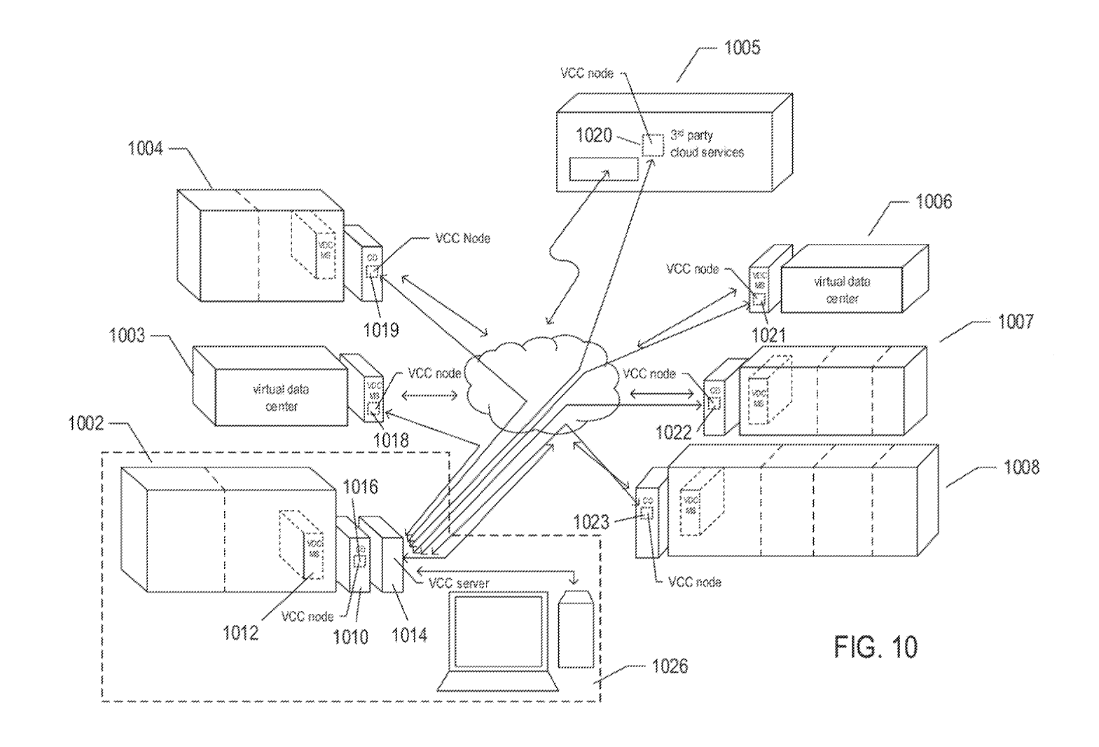

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Systems and Methods of Allocating Network Cost of a Physical Data Center to Tenants

FIG. 11 shows five example virtual-machine execution environments 1101-1105 above a virtual-interface plane 1106 of a physical data center 1108. The physical data center 1108 consists of a virtual-data-center management server 1110 and a PC 1112 on which a virtual-data-center management interface may be displayed to system administrators and other users. The physical data center 1108 additionally includes a number of server computers, such as server computers 1114-1117, that are interconnected to form three local area networks 1118-1120. For example, local area network 1118 includes a switch 1122 that interconnects the four servers 1114-1117 and a mass-storage array 1124 via Ethernet or optical cables and local area network 1120 includes a switch 1126 that interconnects four servers 1128-1131 and a mass-storage array 1132 via Ethernet or optical cables. In this example, the physical data center 1108 also includes a first router 1134 that interconnects the LANs 1118-1120 and interconnects the LANS to the Internet, the virtual-data-center management server 1110, the PC 1112 and to a second router 1136 that, in turn, interconnects other LANs composed of server computers and mass-storage arrays (not shown). In other words, the routers 1134 and 1136 are interconnected to form a larger network of server computers. The routers forward packets of data between the LANs and between the LANs and the Internet. Each switch maintains a record of devices interconnected by the switch that may be in the form of a look-up table and each router also maintains a separate look-up table of devices interconnected by the switches. For example, server computer 1114 transmits a data packet intended for server computer 1131 by sending the packet to the switch 1122. The switch 1122 examines the destination internet protocol address (“IP address”) of the packet, determines the destination server computer 1131 is not listed in the look-up table maintained by the switch 1122 and transmits the packet to the router 1134. The router 1134 also examines the destination IP address of the packet, and based on its own look-up table identifies the destination server computer 1131 as being connected to the switch 1126 and forwards the packet to the switch 1126, which transmits the packet to the server computer 1131.

Although the LANs 1118-1120 are shown as being implemented with cables, in an alternative implementation any one of the LANs used to interconnect server computers, switches and routers in a physical data center may be wireless. For example, one or more of the server computers 1114-1117 may include wireless network interface cards that create wireless communication channels, such as Wi-Fi, between server computers, switches and routers. An Ethernet cable, optical cable and a wireless communication channel are physical communication links.

In the example of FIG. 11, each switch may be configured to form one or more subnetworks using VLAN tagging. For example, when the switch 1122 is configured to form a single subnetwork for the server computers 1114-1117, each server computer is able to uncast, multicast or broadcast data packets to the other server computers interconnected via the LAN 1118 depending on how the switch 1122 is configured. On the other hand, when a switch is configured to form two or more subnetworks, a server computer is able to multicast or broadcast only to those server computers on the same subnetwork. For example, suppose the switch 1122 is configured to form a first subnetwork for the server computers 1114 and 1115 and a second subnetwork composed of the server computers 1116 and 1117. The server computers 1114 and 1115 are able to broadcast over the first subnetwork but not over the second subnetwork. Server computers within one subnetwork are not able to communicate with a server computer on another subnetwork without going through a router. For example, the server computer 1114 of the first subnetwork communicates with the server computer 1116 of the second subnetwork via the router 1134, even though the server computers 1114 and 1116 are on the same LAN 1118.

FIG. 11 also shows that the server computers 1114-1117 and 1131 host virtual-machine execution environments 1101-1105, respectively. Each of the virtual-machine execution environments consists of a virtualization layer and two to four VMs. For example, FIG. 11 shows a magnified view 1138 of the virtual-machine execution environment 1101 which includes a virtualization layer 1140 and four boxes 1141-1144 that each represents a different VM running on the server computer 1114. The VMs 1141-1144 include virtual network interface cards (“vNICs”) that are connected to virtual ports of a virtual switch (“vswitch”) 1146 located in the VMM of the virtualization layer 1140 to form a virtual network. The virtual network enables the VMs 1141-1144 to receive and transmit data between each other on the same server computer. In other words, the virtual network enables intra-host communications between the VMs 1141-1145. Intra-host communications between VMs hosted by the same server computer do not reach other server computers or utilize the physical communication links between server computers, switches, and routers.

As shown in FIG. 11, each vswitch interfaces with a physical network interface card (“pNIC”) of the server computer, which, in turn, is interconnected to a switch via an Ethernet or optical cable. For example, vswitch 1146 interfaces with pNIC 1148 of the server computer 1114 which is connected to a port of the switch 1122 via Ethernet or optical cable 1150. VMs that run on different server computers within the same physical data center receive and transmit data packets over the physical communication links. For example, when the VM 1141 hosted by the server computer 1114 transmits a data packet to a VM 1152 hosted by the server computer 1131, the data packet includes the destination IP address of the server computer 1131 and the VM 1152 and the data packet is forwarded via physical communication channels to the switch 1122, the router 1134, the switch 1126 and to pNIC 1154 of the server computer 1131. The pNIC 1154 transmits the data packet to the VM 152 via a vswitch 1156 of a virtualization layer 1158. The VMs may also receive data packets from, and transmit data packets to, the Internet, the virtual-data-center management server 1110, the PC 1112, and to other VMs hosted by server computers interconnected to the router 1134 over physical communication links. VMs that receive and transmit data packets via physical communication links engage in inter-host communications.

Methods and systems allocate network cost of a physical data center based on a sum of capital expenditure and operational expenditure of the physical data center for a period of time. The period may be any suitable or agreed upon billing period. For example, the period may be a week, a calendar month or a period may be a quarter of a calendar year (i.e., 3 months).

In order to compute the capital expenditure of a physical data center, an inventory of devices connected to various networks of the data center may be determined using network monitoring tools. A network monitoring tool may model LAN and wireless networks, physical and virtual networks and is able to identify all physical devices (e.g., server computers, switches, and routers) connected to each network of the physical data center and associated physical and logical ports.

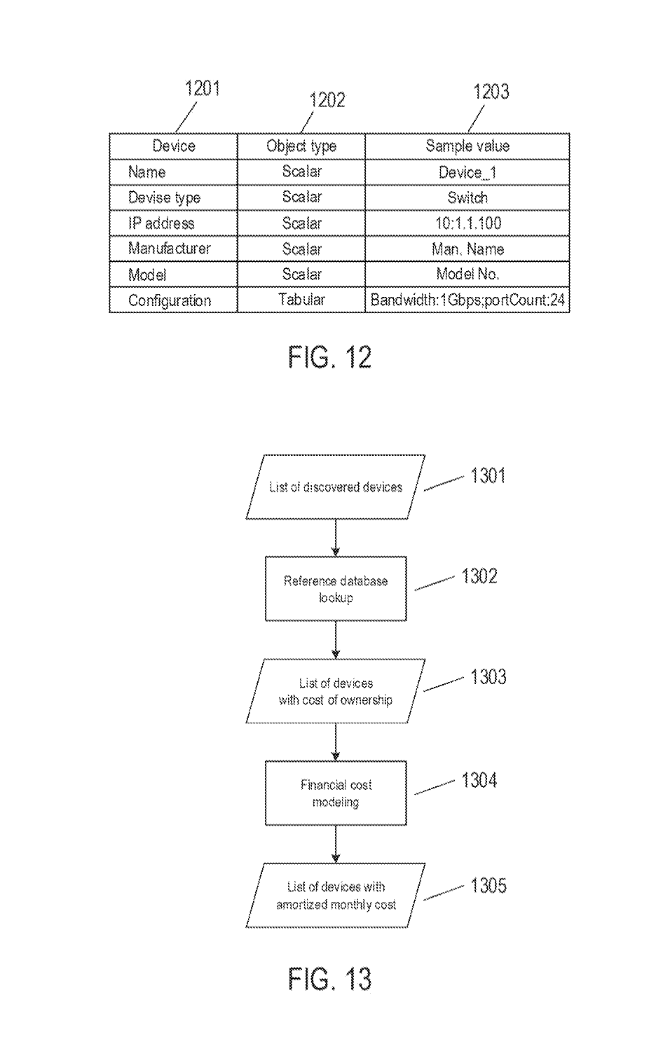

FIG. 12 shows an example table of device information that may be collected for each device connected to a network of a physical data center. The table is composed of three columns. A first column 1201 list various kinds of information that collectively may be used to specifically identify a device connected to the network, such as the device name, device type, IP address, manufacturer, model and device configuration. A second column 1202 list the object data type associated with the kinds of information listed in column 1201. A third column 1203 list the values associated with the kinds of information listed in column 1201. For example, in the second row, the device “Device type” is a “switch.”

A physical device list may be obtained by querying host configurations across clusters in the physical data center. An inventory of the devices connected to networks of the physical data center is formed by combining automatically discovered devices, pNICs, and manually entered cable infrastructure details. Once the list of devices connected to networks of the physical data center has been determined, an amortized cost of each device in the list is computed.

FIG. 13 shows a flow diagram of computing an amortized cost of listed devices. In block 1302, a list of discovered devices 1301 is input and an extensive database of vendor cost is searched in order to associate a cost and market launch date with each of the devices listed to form a list of devices and associated cost of ownership 1303. In block 1304, the list of devices and associated cost of ownership 1303 is received and financial depreciation and amortized cost calculation for the current period is computed for each device in order obtain a list of devices and associated amortized cost 1305.

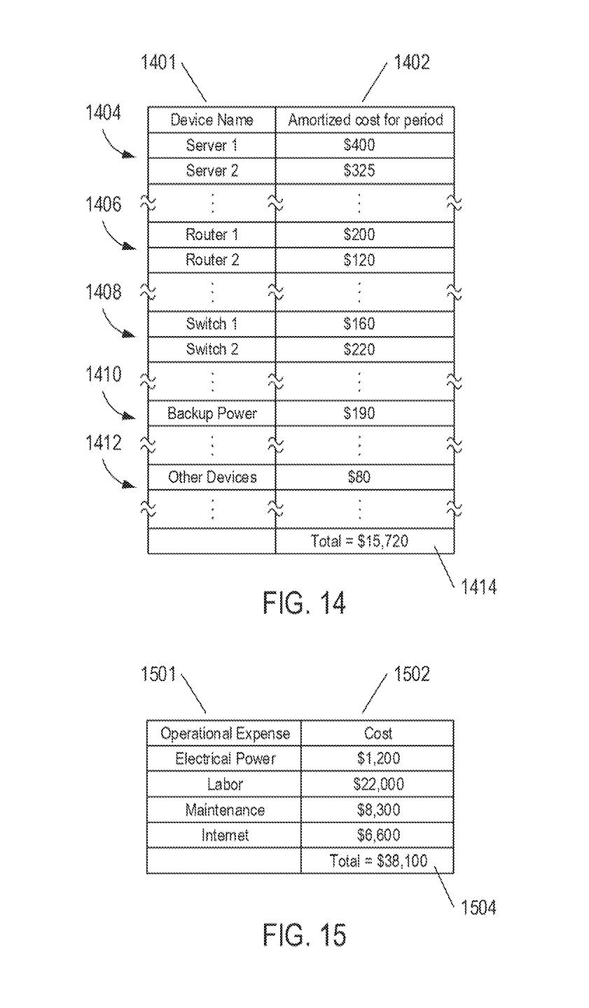

FIG. 14 shows an example table of discovered devices listed in a first column 1401 and corresponding amortized costs of each device for a period of time listed in a second column 1402. The devices include server computers 1404, routers 1406, switches 1408, backup power 1410 and other devices 1412. Each device has a corresponding amortized cost listed in column 1402. A total capital expenditure 1414 for the period is obtained by summing the amortized cost in column 1402, which in this example is $15,720.

Operational expenditure of a physical data center for the period may be computed as the sum of labor cost, Internet cost, data center maintenance cost, and cost of electrical power for each of the discovered devices connected to the networks of the physical data center. The electrical power cost of each device may be obtained from vendor specified power rating in watts. For example, the electrical power cost of a device may be computed as Kilowatts×Hours in period×Power unit cost, where Kilowatts is the vendor specified rating in watts of the device, Hours in period is the number of hours the device was in operation over the full period, and Power unit cost is the cost of electrical power charged by the electrical utility per unit of time.

FIG. 15 shows an example table of operational expenditures for a period of time. Column 1501 lists the operational expenses including “electrical power,” “labor,” “maintenance,” and “Internet.” Column 1502 lists the corresponding cost of each of the operational expenses listed in column 1501. In this example, the total operational expenditure 1504 for a physical data center over the full period is $38,100.

A total network cost of the physical data center for the period of time may be computed by summing the capital expenditure and operational expenditure for the period. In the example of FIGS. 14 and 15, the total network cost, denoted by Cₜ, is $58,820, which is obtained by summing the capital expenditure $15,720 1414 of FIG. 14 and the operation expenditure $38,100 1504 of FIG. 15.

In order to compute an effective network cost for each VM, an effective LAN bandwidth utilization is determined for each VM and an effective LAN bandwidth utilization for all of the VMs is determined. A LAN bandwidth is determined by the bandwidth of the physical communication channels comprising the LAN. For example, for a LAN with N Gb Ethernet cables the maximum network bandwidth between any two devices interconnected on the LAN is N Gbps. In practice, because many device-to-device communications occur in parallel, no single device-to-device communication scales to the maximum. As explained above in the preceding section, in a virtualized environment, network devices are not directly used by VMs. On one level of abstraction, a VMM controls and allocates network devices to the VMs. VMs are connected to virtual ports of a vswitch as described above with reference to FIG. 11. Multiple virtual ports may be combined to form a virtual port group and network configurations occur at the virtual port group level. As a result, each VM has a defined vNIC bandwidth limit. Methods of allocating cost do not directly depend on the vNIC bandwidth configuration because the vNIC bandwidth is automatically accounted for in cost allocation based on an effective LAN bandwidth utilization by the VMs.

Effective LAN bandwidth utilization by all of the VMs running in the physical data center over the full period may be calculated according to

$${U}_{l} = {\sum }_{k = 1}^{K} ( {VMRate}_{k} - {VMInternet}_{k} - {VMIntraHost}_{k} ) \qquad ( 1 )$$

where
K is the number of VMs running in the physical data center over the full period;
VMRatek is the rate at which bytes are received and transmitted by the k-th VM over the full period;
VMInternetₖ is the rate at which bytes are received and transmitted to the Internet by the k-th VM over the full period; and
VMIntraHostₖ is the rate at which bytes are received and transmitted to other VMs on the same host by the k-th VM over the full period.
   The summand of Equation (1), Uₖ=VMRateₖ−VMInternetₖ−VMIntraHostₖ, is the rate at which bytes are received and transmitted by the k-th VM over the LAN and is called as the k-th VM LAN bandwidth utilization. The rates VMRateₖ, VMInternetₖ and VMIntraHostₖ are averaged over the full period, such as a billing cycle. The rate VMRateₖ at which a VM receives and transmits bytes and the rate VMIntraHostₖ at which bytes are received and transmitted to other VMs on the same host may be determined by a network monitoring tool. A network monitoring tool identifies network communications and outputs a list of triplets, such as source IP address, destination IP address, and traffic-rates-in-mbps. If both source IP and destination IP addresses belongs to VMs on the same host, the network monitoring tool categorizes the communication as intra-host. Any network monitoring tool operating on the VMM identifies all data packets transmitted and received on the network interfaces and outputs the list. The rate VMInternetₖ at which the k-th VM transmits and receives data packets is determined by examining the IP addresses of the data packets. When a network monitoring tool determines that a data packet IP address is sent from a source IP or sent to a destination IP with an IP address outside a LAN subnet of the data center, the packet is identified as Internet traffic. Alternatively, the rate VMInternetₖ may be approximated as a percentage of total LAN traffic. In Equation (1), the sum over the rates VMIntraHostₖ represents the intra-host communications, which are subtracted in order to obtain an effective LAN bandwidth utilization based on inter-host communications that use the physical networks of the physical data center. The accuracy of cost allocation methods and systems described below depends in large part on how efficiently average LAN and Internet bandwidth utilization by a tenant's VMs are measured for Equation (1).

Methods and systems compute a cost of running each VM in a physical data center over a period as an effective cost of each VM's use of the physical data center network and the effective cost of each VMs use of the Internet as follows:

eff network cost of VMₖ=eff LAN cost of VMₖ+eff Internet cost of VMₖ (2)

Equation (2) gives an effective network cost of the k-th VM, VMₖ, running in the data center over the full period and computed as a sum of an effective cost of the k-th VM usage of a LAN over the full period given by

$$eff LAN cost of {VM}_{k } = ( = \frac{\frac{{U}_{l}}{{U}_{l} + {U}_{i}} \cdot {C}_{e}}{{U}_{1}} ) \cdot {U}_{k} \qquad ( 3 )$$

and an effective cost of Internet usage by the k-th VM over the full period given by

$$eff Internet cost of {VM}_{k} = ( \frac{\frac{{U}_{i}}{{U}_{l} + {U}_{i}} \cdot {C}_{e} + {C}_{i}}{{U}_{i}} ) \cdot {VMInternet}_{k} \qquad ( 4 )$$

In Equations (3) and (4), the quantity Uₗ is the effective LAN bandwidth utilization given by Equation (1), the quantity Uₖ is the effective LAN bandwidth utilization of the k-th VM, the quantity Uᵢ is total Internet utilization over the full period and the quantity Cᵢ is the cost of the quantity Uₗ over the full period. The Internet usage Uᵢ and Internet cost Cᵢ may be obtained from billing statements charged to the physical data center by an Internet service provider. The quantity Cₑ is the total network cost Cₜ minus the Internet cost Cᵢ over the full period:

Cₑ=Cₜ−Cᵢ (5)

The total network cost Cₜ of the physical data center for the period is obtained by summing the capital and operational expenditure for the physical data center over the full period as described above with reference to FIGS. 14 and 15. In other words, the Internet cost Cᵢ is subtracted from the total capital and operational expenditure Cₜ of the physical data center in order to obtain the cost Cₑ of maintaining the resources of just the physical data center. The numerator of Equation (3) is the effective LAN cost over the full period given by

$$eff LAN cost = \frac{{U}_{l}}{{U}_{l} + {U}_{i}} \cdot {C}_{e} \qquad ( 6 )$$

and the numerator of Equation (4) is the effective Internet cost over the full period given by

$$eff Internet cost = ( \frac{{U}_{l}}{{U}_{l} + {U}_{i}} \cdot {C}_{e} ) + {C}_{i} \qquad ( 7 )$$

The effective network cost of running N VMs in the physical data center over the full period is computed by summing the effective cost of each VM as follows:

$$eff network cost = {\sum }_{{k}^{′}}^{N} eff netw ork cost of {VM}_{k} . \qquad ( 8 )$$

Equation (8) may be used to compute the effective network cost of running N VMs of a tenants VDC, where the index k′ represents each of the tenants VMs.

Returning to FIG. 11, assume that a tenant has an associated VDC composed of the virtual machine execution environments 1101-1104 running on the server computers 1114-1117. As shown in FIG. 11, the tenant's VDC runs 13 VMs. The Internet usage Uᵢ, Internet cost Cᵢ, and total capital and operational expenditure Cₜ are determined for a period of time, such as a billing cycle of one month. The Internet cost Cᵢ is subtracted from the total capital and operational expenditure Cₜ for the physical data center in order to obtain a cost Cₑ of maintaining the resources of just the physical data center shown in FIG. 1. The rates VMRateₖ, VMInternetₖ, and VMIntraHostₖ are determined for each of the 13 VMs over the full period and combined according to Equation (1) in order to compute an effective LAN bandwidth utilization Uₗ by all 13 of the VMs over the full period. Next, an effective network cost, eff network cost of VMₖ, is computed according to Equations (2)-(4) over the full period for each of the 13 VMs. The effective network costs of running the 13 VM over the full period are summed according to Equation (8) in order to obtain a total effective network cost of running all 13 VMs over the full period which may be charged to the tenant.

Note that methods and systems of computing effective LAN and Internet costs for each VM according to Equations (3) and (4) described above do not include VM intra-host communications. VM intra-host communications are not factored into calculating the effective network cost for each VM, because intra-host communications do not use physical communication channels of the physical data center as explained above with reference to FIG. 11. In other words, the methods described above for computing network cost allocation is based on actual utilization of the physical network by the VMs. In addition, a VM's LAN bandwidth utilization Uₖ to LAN bandwidth utilization Uₗ (i.e., Uₖ/Uₗ) is proportional to the total LAN cost allocation for the VM, eff LAN cost of VMₖ, represented by Equation (3) (i.e., Uₖ/Uₗ˜eff LAN cost of VMₖ).

It should also be noted that at the end of computing a network cost allocation for each tenant, there may be some unallocated Internet cost remaining, which may be reported to a data-center manager or a VM scheduler. The data center manager or scheduler may re-schedule VMs in order to optimize unallocated Internet cost. Any unallocated LAN cost for the period may be computed according to

$$unallocated Lan cost = ( \frac{\frac{{U}_{l}}{{U}_{l} + {U}_{i}} \cdot {C}_{e}}{{U}_{l}} ) \cdot ( {B}_{l} - {U}_{l} ) \qquad ( 9 )$$

and any unallocated Internet cost may be computed according to

$$unallocated Internet cost = ( \frac{\frac{{U}_{i}}{{U}_{l} + {U}_{i}} \cdot {C}_{e} + {C}_{i}}{{U}_{l}} ) \cdot ( {B}_{l} - {U}_{l} ) \qquad ( 10 )$$

Thresholds may be used to generate alerts and/or initiate operations that optimize use of the network by rescheduling any one or more of a tenant's VMs or moving the tenant's VMs to different server computers in order to minimize the unallocated LAN cost and/or unallocated Internet cost. For example, when one or both of the following conditions is satisfied:

unallocated LAN cost>Tₗ (11a)

unallocated Internet cost>Tᵢ (11b)

where
Tₗ is the unallocated LAN cost threshold value; and
Tᵢ is an unallocated Internet cost threshold.
   an alert is generated for a data-center manager or a VM scheduler. The data-center manager or scheduler may provision the network by rescheduling a tenant's associated VMs or moving a certain number of the VMs to different server computers in order to minimize the unallocated LAN cost and unallocated Internet cost. In other words, in order to get one or both of unallocated LAN cost and unallocated Internet cost below the respective thresholds.

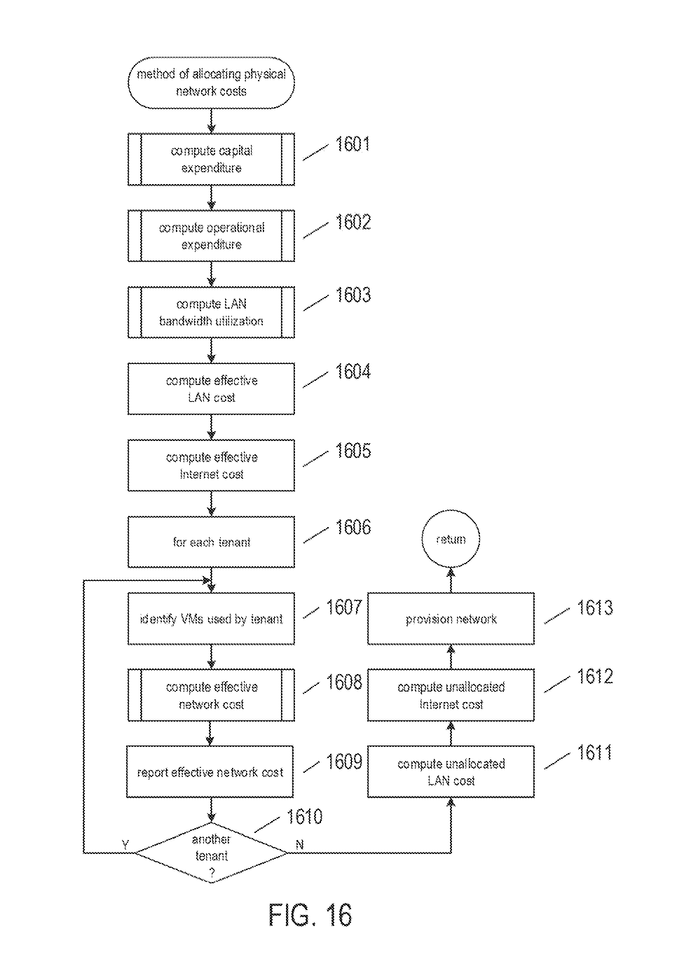

FIG. 16 shows a control-flow diagram of allocating network cost of a physical data center for a period of time. In block 1601, a routine “compute capital expenditure” is called to compute capital expenditure of the physical data center. In block 1602, a routine “compute operational expenditure” is called to compute operational expenditure of the physical date center. In block 1603, a routine “compute LAN bandwidth utilization” is called to compute total LAN bandwidth utilization for networks of the physical data center. In block 1604, an effective LAN cost is computed according to Equation (6). In block 1605, an effective Internet cost is computed according to Equation (7). A for-loop beginning with block 1606 repeats the computational operations represented by blocks 1607-1609 for each tenant of physical data center. In block 1607, VMs associated with a tenant are identified. In block 1608, a routine “compute effective network cost” is called to compute an effective network cost of running the VMs associated with the tenant according to Equation (8). In block 1609, the effective network cost is reported and billed to the tenant as the cost of running the tenant's VM in the physical data center. In decision block 1610, when the operations represented by blocks 1607-1609 have been computed for all tenants, control flows to block 1611. Otherwise, the operations represented by blocks 1607-1609 are repeated for another tenant of the physical data center. In block 1611, unallocated LAN cost is computed according to Equation (9). In block 1612, unallocated Internet cost is computed according to Equation (10). In block 1613, when the unallocated LAN cost and/or the unallocated Internet cost are greater than associated thresholds as described above with reference to Equations (11a) and (11b), an alert may be generated and a data-center manager, or a VM schedule, may re-provision the VMs in order to optimize use of the physical data center resources.

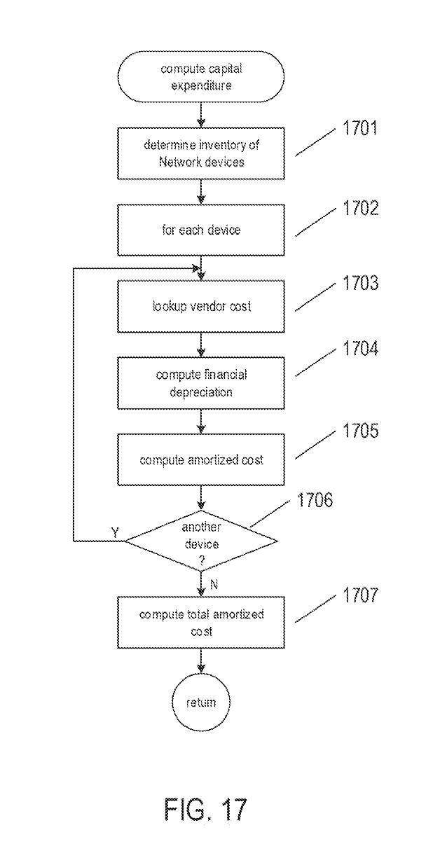

FIG. 17 shows a control-flow diagram of the routine “compute capital expenditure” called in block 1601 of FIG. 16. In block 1701, an inventory of network connected devices of the physical data center is determined by combining automatically discovered devices, pNICs, and manually entered cable infrastructure details. A for-loop beginning with block 1702 repeats the computational operations represented by blocks 1703-1706 for each device discovered in block 1701. In block 1703, the cost of a device is determined from a database of vendor cost. In block 1704, financial depreciation is computed. In block 1705, amortized cost of the device is computed based on the vendor cost, interest, and number of payments. In decision block 1706, when operations of block 1703-1705 have been applied to all of the devices connected to networks of the physical data center, control flows to block 1707. Otherwise, the operations associated with blocks 1703-1705 are repeated for another device. In block 1707, the amortized cost of the devices are summed to obtain the capital expenditure of the physical data center for the period, as described above with reference to FIG. 14.

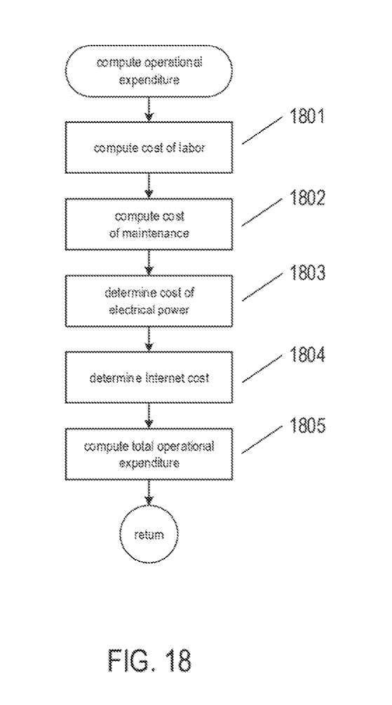

FIG. 18 shows a control-flow diagram of the routine “compute operational expenditure” called in block 1602 of FIG. 16. In block 1801, labor cost for the physical data center are computed for the period. In block 1802, maintenance cost for the data center are computed based on any cost paid by the physical data center to maintain facilities. In block 1803, cost of electrical power used by the physical data center is determined. In block 1804, Internet cost, Cᵢ, of the period is determined the amount paid to an Internet service provider. In block 1805, the labor cost, maintenance cost, electrical power cost, and Internet cost are summed to obtain the total operation expenditure by the physical data center for the period.

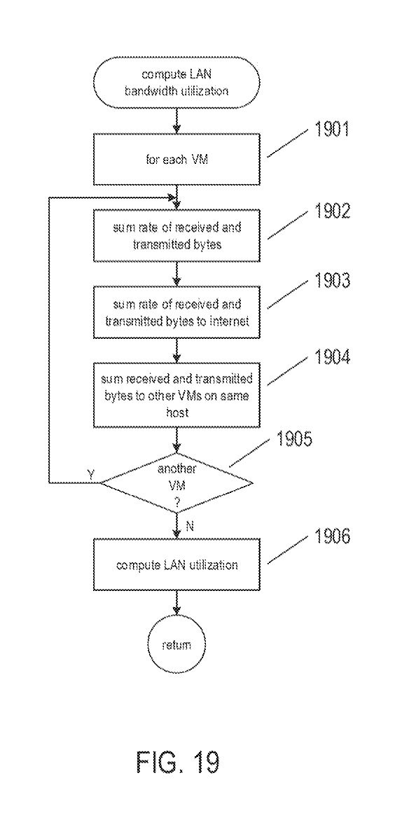

FIG. 19 shows a control-flow diagram of the routine “compute LAN bandwidth utilization” called in block 1603 of FIG. 16. A for-loop beginning with block 1901 repeats the computational operations represented by blocks 1902-1905 for all of the VMs running in the physical data center. In block 1902, the rate at which bytes are received and transmitted by the k-th VM, VMRateₖ, are summed as described above with reference to Equation (1). In block 1903, the rate at which bytes are received and transmitted to the Internet by the k-th VM, VMInternetₖ, are summed as described above with reference to Equation (1). In block 1904, the rate at which bytes are received and transmitted to other VMs on the same host by the k-th VM, VMIntraHostₖ, are summed as described above with reference to Equation (1). In decision block 1905, the operations represented by blocks 1902-1904 are repeated for each of the VMs run over the full period. In block 1906, the sums accumulated in blocks 1902, 1903, and 1904 are combined as represented in Equations (1) to give an effective LAN bandwidth utilization of the VMs running over the full period.

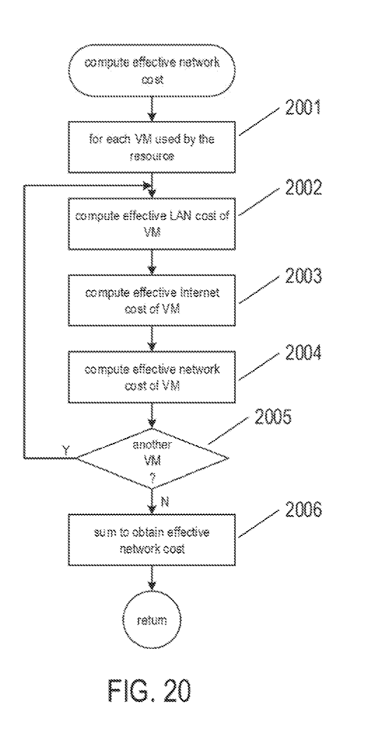

FIG. 20 shows a control-flow diagram of the routine “compute effective network cost” called in block 1608 of FIG. 16. A for-loop beginning with block 2001 repeats the computational operations of blocks 2002-2004 for each VM associated with a tenant. In block 2002, an effective LAN cost is computed for a VM according to Equation (3). In block 2003, an effective Internet cost is computed for the VM according to Equation (4). In block 2004, an effective network cost for the VM is computed as a sum of the effective LAN cost of the VM and the effective Internet cost of the VM according to Equation (2). In decision block 2005, when the operations represented by blocks 2002-2004 have been executed for all of the VMs associated with the tenant, control flow to block 2006. Otherwise, the operations represented by blocks 2002-2004 are repeated for another VM associated with the tenant. In block 2006, the effective network cost of each of the VMs associated with the tenant summed according to Equation (8) in order to obtain an effective network cost for all of the VMs associated with tenant over the full period.

Although the description of methods and systems above is directed to VMs of a VDC, methods and systems are not intended to be so limited in application. The methods and systems may be applied to non-virtual devices and a combination of virtual and non-virtual devices of a physical data center. For example, Equations (2)-(8) may be applied to physical servers of a physical data center by simply replacing the notational representation for a VM, VMₖ, by a server computer denoted by serverₖ with Equation (1) replaced by

$${U}_{l} = {\sum }_{h = 1}^{H} ( {NetworkRate}_{h} - {VMInternet}_{h} ) \qquad ( 12 )$$

where
H is the number hosts;
NetworkRateₕ is the rate at which bytes are received and transmitted by the h-th host over the full period; and
VMInternetₕ is the is the rate at which bytes are received and transmitted to the Internet by the h-th host over the full period.
   In still other implementations, Equations (1)-(12) may be expanded to include both VMs and servers.

For the sake of simplicity, implementation of the methods and systems are described above for a single physical data center. But methods and systems are not intended to be so limited in scope of application. Methods and systems described above may be applied to any number of physical data centers used to run a tenant's numerous VDC composed of any number of VMs. Methods and systems are also not restricted to physical data centers but may also be applied to cloud computing facilities composed of physically distributed networks of servers, switch, routers and mass-storage devices.

It is appreciated that the various implementations described herein are intended to enable any person skilled in the art to make or use the present disclosure. Various modifications to these implementations will be readily apparent to those skilled in the art, and the generic principles defined herein may be applied to other implementations without departing from the spirit or scope of the disclosure. For example, any of a variety of different implementations can be obtained by varying any of many different design and development parameters, including programming language, underlying operating system, modular organization, control structures, data structures, and other such design and development parameters. Thus, the present disclosure is not intended to be limited to the implementations described herein but is to be accorded the widest scope consistent with the principles and novel features disclosed herein.

1. A method of allocating network cost of a cloud computing facility to tenants, the method comprising:
computing capital and operational expenditures of the facility for a period of time;
computing local area network bandwidth utilization of computational entities run in the facility for the period;
computing effective local area network and Internet cost of the facility for the period; and
for each tenant of the facility, computing effective network cost of one or more computational entities run by a tenant of the facility for the period based on the expenditures, local area network utilization, and the effective local area network and Internet cost.

2. The method of claim 1, wherein the computational entities are one of virtual machines, servers, and a combination of virtual machines and servers.

3. The method of claim 1, wherein the cloud computing facility further comprises one or more physical data centers.

4. The method of claim 1, wherein computing the local area network bandwidth utilization further comprises
computing a sum of computational entity rates at which bytes are received and transmitted by each of the computational entities that run in the facility;
subtracting a sum of Internet rates at which bytes are received and transmitted to the Internet by the computational entities that run in the facility; and
subtracting a sum of intra-host communications by the computational entities that run in the facility.

5. The method of claim 1, wherein computing the effective local area network cost further comprises
computing a ratio of the effective local area network bandwidth utilization to a sum of the effective local area network bandwidth utilization and Internet usage; and
multiplying the ratio by the capital and operational expenditures minus Internet cost.

6. The method of claim 1, wherein computing the effective Internet cost further comprises
computing a ratio of the effective local area network bandwidth utilization to a sum of the effective local area network bandwidth utilization and Internet usage;
multiplying the ratio by the capital and operational expenditures minus Internet cost; and
adding total Internet usage cost to that product of the ratio and the capital and operational expenditures minus Internet cost.

7. The method of claim 1, wherein computing the effective network cost further comprise
identifying computational entities the tenant runs in the facility over the full period;
for each identified computational entity,
computing effective local area network cost of the computational entity based on the effective local area network cost,
computing effective Internet cost of the computational entity based on the effective Internet cost, and
computing effective network cost as a sum of the effective local area network cost and the effective Internet cost; and
summing effective network cost of each computational entity to generate an effective network cost the identified computational entities.

8. The method stored in one or more data-storage devices and executed using one or more processors of a computing environment.

9. A system for adjusting a hard threshold comprising:
one or more processors;
one or more data-storage devices; and
a routine stored in the data-storage devices and executed using the one or more processors, the routine
computing capital and operational expenditures of the facility for a period of time;
computing local area network bandwidth utilization of computational entities run in the facility for the period;
computing effective local area network and Internet cost of the facility for the period; and
for each tenant of the facility, computing effective network cost of one or more computational entities run by a tenant of the facility for the period based on the expenditures, local area network utilization, and the effective local area network and Internet cost, and
storing the effective network cost in the one or more data-storage devices.

10. The system of claim 9, wherein the computational entities are one of virtual machines, servers, and a combination of virtual machines and servers.

11. The system of claim 9, wherein the cloud computing facility further comprises one or more physical data centers.

12. The system of claim 9, wherein computing the local area network bandwidth utilization further comprises
computing a sum of computational entity rates at which bytes are received and transmitted by each of the computational entities that run in the facility;
subtracting a sum of Internet rates at which bytes are received and transmitted to the Internet by the computational entities that run in the facility; and
subtracting a sum of intra-host communications by the computational entities that run in the facility.

13. The system of claim 9, wherein computing the effective local area network cost further comprises
computing a ratio of the effective local area network bandwidth utilization to a sum of the effective local area network bandwidth utilization and Internet usage; and
multiplying the ratio by the capital and operational expenditures minus Internet cost.

14. The system of claim 9, wherein computing the effective Internet cost further comprises
computing a ratio of the effective local area network bandwidth utilization to a sum of the effective local area network bandwidth utilization and Internet usage;
multiplying the ratio by the capital and operational expenditures minus Internet cost; and
adding total Internet usage cost to that product of the ratio and the capital and operational expenditures minus Internet cost.

15. The system of claim 9, wherein computing the effective network cost further comprise
identifying computational entities the tenant runs in the facility over the full period;
for each identified computational entity,
computing effective local area network cost of the computational entity based on the effective local area network cost,
computing effective Internet cost of the computational entity based on the effective Internet cost, and
computing effective network cost as a sum of the effective local area network cost and the effective Internet cost; and
summing effective network cost of each computational entity to generate an effective network cost the identified computational entities.

16. A computer-readable medium encoded with machine-readable instructions that implement a method carried out by one or more processors of a computer system to perform the operations of
computing capital and operational expenditures of the facility for a period of time;
computing local area network bandwidth utilization of computational entities run in the facility for the period;
computing effective local area network and Internet cost of the facility for the period; and
for each tenant of the facility, computing effective network cost of one or more computational entities run by a tenant of the facility for the period based on the expenditures, local area network utilization, and the effective local area network and Internet cost.

17. The medium of claim 16, wherein the computational entities are one of virtual machines, servers, and a combination of servers and virtual machines.

18. The medium of claim 16, wherein the cloud computing facility further comprises one or more physical data centers.

19. The medium of claim 16, wherein computing the local area network bandwidth utilization further comprises
computing a sum of computational entity rates at which bytes are received and transmitted by each of the computational entities that run in the facility;
subtracting a sum of Internet rates at which bytes are received and transmitted to the Internet by the computational entities that run in the facility; and
subtracting a sum of intra-host communications by the computational entities that run in the facility.

20. The medium of claim 16, wherein computing the effective local area network cost further comprises
computing a ratio of the effective local area network bandwidth utilization to a sum of the effective local area network bandwidth utilization and Internet usage; and
multiplying the ratio by the capital and operational expenditures minus Internet cost.

21. The medium of claim 16, wherein computing the effective Internet cost further comprises
computing a ratio of the effective local area network bandwidth utilization to a sum of the effective local area network bandwidth utilization and Internet usage;
multiplying the ratio by the capital and operational expenditures minus Internet cost; and
adding total Internet usage cost to that product of the ratio and the capital and operational expenditures minus Internet cost.

22. The medium of claim 16, wherein computing the effective network cost further comprise
identifying computational entities the tenant runs in the facility over the full period;
for each identified computational entity,
computing effective local area network cost of the computational entity based on the effective local area network cost,
computing effective Internet cost of the computational entity based on the effective Internet cost, and
computing effective network cost as a sum of the effective local area network cost and the effective Internet cost; and
summing effective network cost of each computational entity to generate an effective network cost the identified computational entities.
